(19) United States
(12) Patent Application Publication
(10) Pub. No.: US 2020/0078845 A1
(43) Pub. Date: Mar. 12, 2020

(54) MANUFACTURING METHOD OF AN UNEQUAL-TORQUE COIL SPRING AND A MANUFACTURING MACHINE THEREOF FOR A CURTAIN SPRING MOTOR

(71) Applicants: Hsien-Te HUANG, Taipei City (TW); ANLI SPRING CO., LTD., New Taipei City (TW)

(72) Inventors: Hsien-Te HUANG, Taipei City (TW); Ta-Peng HUANG, Taipei City (TW)

(21) Appl. No.: 16/204,282

(22) Filed: Nov. 29, 2018

(30) Foreign Application Priority Data
Sep. 7, 2018 (TW) 107131400

(51) Int. Cl. B21D 11/06; F03G 1/02; B21D 53/00; B21D 11/10; B21D 5/00; B21D 5/14

(52) U.S. Cl. CPC B21D 11/06; F03G 1/02; B21D 53/00; F03G 2730/01; B21D 5/002; B21D 5/14; B21D 11/10

(57) ABSTRACT

The present invention discloses a manufacturing method of an unequal-torque coil spring and a manufacturing machine thereof for a curtain spring motor, providing a feedback torque that corresponds to an actual requirement from different stages in a curtain-folding working process, so that when the curtain is folded back, the torque can be used to stabilize the speed of folding back the curtain, and the lower beam of the curtain can be fixed at any heights as the curtain is lowered.

### BACKGROUND OF THE INVENTION

### a) Field of the Invention

The present invention relates to a manufacturing method of an unequal-torque coil spring and a manufacturing machine thereof for a curtain spring motor, and more particularly to a manufacturing method of an unequal-torque coil spring and a manufacturing machine thereof, providing feedback torque corresponding to an actual requirement from different stages in a curtain-folding working process.

### b) Description of the Prior Art

For the purpose of safely using curtains, designs of curtain sets without exposed pull cords have been tirelessly developed in the industry. As shown in FIG. 1, a curtain set 1 uses a spring motor 2 to produce a feedback force; after a lower beam 14 is pulled downwards and becomes lowered, a downward pulling force from a pull cord 12 is transmitted and stored in an equal-torque coil spring 20 inside of a spring motor 2 via a first reel drum 21 and a second reel drum 22. When a curtain 15 is folded back, the force stored in the spring motor 2 can be fed back and output to the lower beam 14, so that a safe design in which the curtain 15 can be folded back by a self-generated force without a pull cord may be applied. The present inventor has already filed a patent application Ser. No. 15/439,313 for the corresponding equal-torque coil spring 20 design.

Further, the spring motor 2 employs an elastic reaction force of approximately equal torque from a strip of equal-torque coil spring 20 to drive the first reel drum 21 and the second reel drum 22 at two sides, so as to reversely reel back the pull cord 12 at both sides and pull up the lower beam 14 by using the force stored in the equal-torque coil spring 20, thereby achieving the objective of folding back the curtain 15. To lower the curtain 15, a user pulls the lower beam 14 downwards, and an action force is transmitted to the first reel drum 21 and the second reel drum 22 via the linkage of the pull cord 12 and the turning of a turning component 13, and then the force is reversely output to the equal-torque coil spring 20 for storage via the first reel drum 21 and the second reel drum 22, so that the force can be used to fold back the curtain 15 later.

The equal-torque coil spring 20 is of a spiral shape, and generates an effective torque curve that is close to being horizontal, which is difficult to match the gravity force of unequal masses accumulated from setting the curtain 15 to different heights. Therefore, it is often necessary to add weights that are hung from the curtain and repeatedly adjust a torque value of a single curtain set 1 during production, in order to achieve a steady folding speed.

Referring to FIGS. 2 and 3, the spring motor 2 comprises a housing 201 assembled and provided with an axle 23 being combined with a chainring 230, and a coiling axle 24 being combined with a linking chainring 240; the chainring 230 and the linking chainring 240 are engaged with each other, and have the first reel drum 21 and the second reel drum 22 pivoted and disposed longitudinally at a front end and a rear end, respectively; the first reel drum 21 and the second reel drum 22 are respectively provided with a first chainring 210 and a second chainring 220, which are respectively engaged with the chainring 230 and the linking chainring 240. A detachable bearing 231 is sleeved outside of a cylindrical surface of the axle 23, and a cylindrical surface of the detachable bearing 231 allows a spiral inner circle of the equal-torque coil spring 20 to sleeve on; a release end of the equal-torque coil spring 20 is a joining end 200 which is joined to a radial cylindrical surface of the coiling axle 24.

Referring back to FIG. 1, when the lower beam 14 is pulled downwards, the generated force is released from the axle 23 to the coiling axle 24 as the equal-torque coil spring 20 is coiled around by the coiling axle 24, and the affected equal-torque coil spring 20 will generate a recovery coiling force (feedback force), when the lower beam 14 is pushed upwards, the feedback force from the equal-torque coil spring 20 is activated and released to reverse the equal-torque coil spring 20 back to the position of the axle 23. The reverse process happens as follows: the linking chainring 240 of the coiling axle 24 drives the second reel drum 22 via the second chainring 220 and then drives the first reel drum 21 via the chainring 230, so that the pull cords 12 at both sides are reeled back by linking the first reel drum 21 and the second reel drum 22.

In the aforesaid process, a coiling speed of the equal-torque coil spring 20 is different from that of the chainring 230 due to the presence of the detachable bearing 231, the chainring 230 solely serves the purpose of shifting the force in this case, and shifts a force resulted from the first reel drum 21 being pulled by the pull cord 12 and transfers the force to the linking chainring 240 of the coiling axle 24. Similarly, when the second reel drum 22 at the right is pulled by the pull cord 12, the second chainring 220 can also transfer the force to the coiling axle 24, so that the coiling axle 24 can pull and coil the equal-torque coil spring 20, and the equal-torque coil spring 20 sequentially releases the force and turns around a center of a diameter thereof when it is pulled and coiled around by the coiling axle 24.

Referring to FIG. 4, which shows the curtain 15 that has been folded upwards completely. When the disposed lower beam 14 is pulled by the pull cord 12 and moved upwards, each curtain piece 150 is sequentially accumulated on an upper surface of the lower beam 14; consequently, a plurality of curtain pieces 150 are accumulated and form a total mass W of the stacked curtain pieces, which results in a maximum pulling force from the pull cord 12 at this moment. In comparison, the pull cord 12 also withstands the maximum pulling force at this moment, and holds the lower beam 14 to keep it from falling downwards.

When the curtain piece 15 is completely lowered, the lower beam 14 is at a lowest position which is a fifth height H5, and the pulling force withstood by the pull cord 12 is the minimum at this moment as it only needs to support the mass of the lower beam 14 now. Therefore, within the range of a total lift height H0, as the lower beam 14 has the curtain pieces 150 accumulated on top of it one by one from the bottom, the weight load of the curtain pieces 150 gradually increases as a result, and the weight load reaches maximum when the lower beam 14 reaches the top, and becomes minimum when the lower beam 14 is at the bottom.

In addition, when it reaches a third height H3 defined in the curtain folding process, the spring motor 2 needs to produce a balancing pulling force against the lower beam 14 when it is located at the third height H3, so as to prevent the lower beam 14 from falling downwards, while the spring motor 2 also needs to avoid producing excessive pulling force that pulls the lower beam 14 upwards.

When the lower beam 14 is located at the lowest position which is the fifth height H5, and being pulled upwards to a first height H1, an upward momentum is generated from the combined factor between a mass of the lower beam 14 and a pulling speed of the pull cord 12. Therefore, it would be ideal to have the pulling force from the pull cord 12 lessened when the lower beam 14 reaches a second height H2, so as to achieve a buffering effect, and then have the spring motor 2 output a smaller torque again in order to slowly pull up the lower beam 14 located at the second height H2 to the first height H1, so as to prevent the momentum from the lower beam 14 to impact on a lower part of an upper beam 11.

Referring to FIG. 5, two sides of each of the curtain pieces 150 are respectively combined with ladder strings 120 at two sides, and two ladder strings 120 form a top-to-bottom linkage between a pitch P to support the curtain pieces 150. Consequently, each of the curtain pieces 150 are linked from top to bottom, and topmost ends of the ladder strings 120 are combined with the upper beam 11. As shown in the figure, when the lower beam 14 is located at a half-height position Hn, the weight of the total mass W of the stacked curtain pieces is withstood by the upper surface of the lower beam 14; when the pull cord 12 is pulling upwards or supporting the curtain in a fixed position, the ladder strings 120 help support the total weight of all curtain pieces 150 interspaced by the pitch P.

As the lower beam 14 is lowered, the feedback torque stored in the spring motor 2 is needed for fixing the lower beam 14 at the half-height Hn position, while the upper surface of the lower beam 14 is supporting the total mass W of the stacked curtain pieces at Hn at the same time. Thus as the lower beam 14 moves upwards, greater balancing torque is needed from the spring motor 2. In contrast, as the lower beam 14 moves downwards, the torque needed from the spring motor 2 declines proportionately. Subsequently, the required working torque curve from the spring motor 2 turns from steep to flat.

To allow the spring motor 2 of the curtain set 1 to produce the torque needed for folding back the curtain 15 during the curtain folding process, as disclosed in U.S. Pat. No. 6,283,192 B1; the main technical feature is related to the longitudinal area of a strip of spring, and a method of boring holes to form weak points is utilized to distribute bore holes of unequal sizes and distances, so that the strip of spring can have different elastic actions at a front end and a back end. For producing feedback torque output for actual system requirements based on simulations, and another patent U.S. Pat. No. 5,482,100, a strip of spring is formed with different thicknesses or widths at a front end and a back end in order to produce elastic reactions that result in varied torque to meet the actual requirements for torque. But the method of boring holes leads to weaknesses in the strip of spring, which results in the problems of mechanical damage and difficulty in processing. Further, because the strip of spring is a very thin metal slice that needs to have different thicknesses and widths at a front end and a rear end, the processing control for making increasing or decreasing thicknesses and widths needs to be extremely precise, which makes the production of the spring difficult and time-consuming.

An ordinary way for making an unequal-torque coil spring of a curtain spring motor uses a method for disposing different curvatures in multiple front and rear sections of a reed strip, so as to provide a feedback force as multiple levels of torque in response to actual working requirements from a curtain system loading end capable of arranging a curtain at different heights, so that a lower beam can be fixed at any positions.

Referring to FIGS. 6-8 (with reference to FIG. 9), the present inventor has provided a strip of a reed strip 3 forming different curvatures disposed as different levels, with an initial curvature A0, a first curvature A1, a second curvature A2, a third curvature A3 and a fourth curvature A4. Each of the unequal curvatures is made by bending the strip toward an identical inner circle. Each of the different curvatures are disposed in the same reed strip 3, and because the electronic spatial structures of different sections of the strip are modified by bending, the resulted elastic reactions of the different sections in the coiled equal-torque coil spring 30 (as shown in FIG. 10) are different, which gives rise to unequal elastic forces (torque) output from different sections of the strip in the curtain.

Referring to FIG. 9 again, the reed strip 3 has an initial curvature A0 disposed in a section starting from a joining end 300 to a first length L1, and a torque generated therefrom is an increasing torque TC that increases suddenly; a first curvature A1 disposed in a section starting from the first length L1 to a second length L2, and the first curvature A1 generates a first torque T1 which is of a slowly increasing arc when viewed on the curvature graph; a second curvature A2 disposed in a section starting from the second length L2 to a third length L3 to form a second torque T2, and the second torque T2 is a constant torque which is of a curve extending from a highest torque output of the first torque T1 when viewed on the curvature graph; a third curvature A3 disposed in a section starting from the third length L3 to a fourth length L4, and the curvature of the third curvature A3 decreases to form a third torque T3; a fourth curvature A4 disposed in a section starting from the fourth length L4 to a fifth length L5, and the curvature of the fourth curvature A4 can be made less to form a smaller fourth torque T4 (points connecting the above-described torque curves are not changed suddenly, but have lines preceding and following the points slowly changing, the description about the points is omitted for the purpose of simplification).

For the purpose of meeting the requirement of forces corresponding to the actual curtain-folding working process, as well as easy fabrication, the reed strip 3 is fabricated by bending several sections separately to allow for the generation of several different torque forces, wherein the second torque T2 is the maximum, and the third torque T3 following the second torque T2 decreases by sloping downwards; the torque forces after the fifth length L5 are not included for consideration.

Referring to FIG. 10 and FIG. 11, in which a structure of the formed unequal-torque coil spring 30 can be simplified into 3 layers overall; a curvature of an inner spiral layer C3 gradually becomes less than that of an outer spiral layer C1, and a curvature of a mid-spiral layer C2 is also less than that of the outer spiral layer C1. Under a stationary condition, the unequal-torque coil spring 30 can form a self-binding force toward a center thereof to maintain a circular shape.

A ratio between the above-described torque forces can be set between 4:1, and the reed strip 3 is formed into an unequal-torque coil spring 30 by coiling, and comprises the outer spiral layer C1, the mid spiral layer C2, the inner spiral layer C3 and a joining end 300 disposed at an exposed end of the reed strip 3.

Referring to FIG. 11, the ordinary unequal-torque coil spring 30 is implemented in a housing 201 of a spring motor 2, the unequal-torque coil spring 30 is sleeved outside of a cylindrical surface of an axle 23 around an identical center, but is not linked to the axle 23; the joining end 300 disposed at a free end of the reed strip 3 is joined to a cylindrical surface of a coiling axle 24 and linked thereto; an end of the coiling axle 24 is linked to a linking chainring 240, and when driven by a chainring 220 of a second reel drum 22 or a chainring 210 of a first reel drum 21, the linking chainring 240 drives the unequal-torque coil spring 30 to coil toward the direction of the coiling axle 24. Under a stationary condition, the outer spiral layer C1 of the unequal-torque coil spring 30 has the maximum torque and is the first to be coiled into the outer circle of the coiling axle 24; when outputting a feedback torque, the outer spiral layer C1 is the last to be output.

Referring to FIG. 12, the unequal-torque coil spring is applied to the spring motor 2 in a curtain set 1 for folding back a curtain 15. Torque required for curtain-folding is different between a first height H1, a second height H2, a third height H3, a fourth height H4 and a fifth height H5. If a lower beam 14 is folded to a position between the third height H3 and the second height H2, the spring motor 2 withstands a maximum torque that is the second torque T2; the distance between the second height H2 and the first height H1 is the last folding step and is the shortest, and the remaining momentum from the second torque T2 generated for the curtain-folding process is sufficient for uploading a total mass W of the stacked curtain pieces. Therefore, the first torque T1 is only used for pulling and supporting an overall weight resulted from accumulating the total mass W of all stacked curtain pieces 150 and preventing the curtain 15 from falling downward, so the torque of the first torque T1 can be gradually decreased as it approaches the position of the first length L1. In other words, the torque from the first length L1 is able to withstand the total mass W of the stacked curtain pieces.

The second torque T2 generated from the longitudinal section of the reed strip 3 from the second length L2 to the third length L3 is a constant torque that corresponds to the curtain-folding process from the third height H3 to the second height H2 in the curtain set 1; when the curtain 15 is folded upwards, the torque T2 provides the maximum torque for the lower beam 14 to withstand the loading weight of curtain pieces sequentially accumulated on a top surface thereof, and for pulling the lower beam 14 to the second height H2. Subsequently, the first torque T1 is used to return the lower beam 14 to the first height H1. The purpose of having the first torque T1 less than the second torque T2 is to ease a momentum generated from the mass of the curtain 15 and the rising speed before the curtain 15 is folded back to destination (the first height H1), so that a buffering effect can be achieved before the curtain-folding completes, thereby ensuring safe use.

The third torque T3 generated from the section of the reed strip 3 from the third length L3 to the fourth length L4 is a decreasing torque, and the fourth torque T4 generated from the section from the fourth length L4 to the fifth length L5 is less than the third torque T3; the load of the fourth torque T4 is the smallest.

During the folding of curtain, the lower beam 14 is pulled upwards from the fifth height H5 and starts to sequentially accumulate each of the curtain pieces 150 arranged above, and then the third torque T3 takes over as more force is needed for folding when the lower beam 14 reaches the fourth height H4, and the third torque T3 rapidly generates a higher torque to relay the folding process to the second torque T2.

Each of the described levels of torque is able to generate a stopping and fixing force according to any needs when the lower beam 14 is located at any positions within a total lift height H0, so as to prevent the lower beam 14 at a particular height to fall downwards or rise upwards.

In this embodiment, the reed strip 3 corresponds to a measurement of the total lift height H0, and the torque distribution is as follows: the first torque T1 is generated from the section between the first length L1 and the second length L2, the second torque T2 is generated from the section between the second length L2 and the third length L3, the third torque T3 is generated from the section between the third length L3 and the fourth length L4, and the fourth torque T4 is generated from the section between the fourth length L4 and the fifth length L5.

The curve graph shows the second torque T2 as one that needs to withstand a greater torque, and the third torque T3 and the fourth torque T4 can both be decreasing. This method of implementation can achieve a very steady speed for folding the curtain 15. In a most ideal system of mechanics, the most precise curve lines are distributed in a sloping torque curve based on geometric coordinates, for the purpose of easily manufacturing the unequal-torque coil spring and providing forces required for folding the curtain 15.

Referring to FIG. 13 and complemented by FIG. 12, the torque curve T0 starts from zero and reaches the first length L1 at a great angle of elevation, and achieves a force of 0.5 Kg that is the first torque T1, for instance. The first torque T1 is generated from a level between the first length L1 and the second length L2, and the torque curve of the first torque T1 can be a sloping line or an arc. The second torque T2 generated from the section between the second length L2 and the third length L3 is the maximum constant torque; the third torque T3 generated from the section between the third length L3 and the fourth length L4 decreases at a great downward sloping rate or as an arc; the fourth torque T4 generated from the section between the fourth length L4 and the fifth length L5 is constant.

### SUMMARY OF THE INVENTION

A primary objective of the present invention is to disclose a manufacturing method of an unequal-torque coil spring and a manufacturing machine thereof for a curtain spring motor, providing feedback torque from the unequal-torque coil spring in response to requirements for different forces in different stages of a curtain-folding working process to result in different corresponding torque. When the curtain is folded back, the torque is used to stabilize the speed of folding back the curtain, and the lower beam of the curtain can be fixed at any heights as the curtain is lowered.

A second objective of the present invention is to disclose a manufacturing method of an unequal-torque coil spring and a manufacturing machine thereof for a curtain spring motor, wherein a pillow module is provided with a clipping gap, an outer end of the clipping gap is a discharging orifice, a side of the discharging orifice is provided with an axis which is parallel to a long side of the clipping gap, the axis is provided with a joggling wheel which adjusts opposite to the discharging orifice, and a rear end of the pillow module is provided with a delivery mechanism having a pushing route which is overlapped with the discharging orifice. The delivery mechanism pushes a reed strip, and the reed strip is abutted by the discharging orifice and is then interfered by the jogging wheel to curl into the unequal-torque coil spring along the same direction.

A third objective of the present invention is to disclose a manufacturing method of an unequal-torque coil spring and a manufacturing machine thereof for a curtain spring motor, wherein the initially curled coil is directed by a guiding device to yield at a side of the pillow, so that an inner curve in the curled section that accomplishes the curling operation can confront to a sliding surface of the pillow, making a feed-in space on the opposite surface by the configuration of the curled section; the feed-in space provides an operational space for a blade of a cutting device to feed in on the inner curve of the curled section upon performing the cutting operation.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a front structural view of an assembly of an ordinary curtain set.

FIG. 2 is a three-dimensional structural view of an ordinary spring motor.

FIG. 3 is an assembled structural top view of the ordinary spring motor.

FIG. 4 is a schematic view showing the requirement of force for the curtain-folding process of the ordinary curtain set.

FIG. 5 is a lateral status view showing a lower beam of the ordinary curtain set located at the middle of a full lift height.

FIG. 6 is a three-dimensional schematic view showing an ordinary reed strip being bent into a first curvature.

FIG. 7 is a three-dimensional schematic view showing the ordinary reed strip being bent into a second curvature.

FIG. 8 is a three-dimensional schematic view showing the ordinary reed strip being bent into a third curvature and a fourth curvature.

FIG. 9 is a schematic view showing the ordinary reed strip being bent into unequal curvatures at a front end and a rear end.

FIG. 10 is a top view of the ordinary reed strip being bent into an unequal-torque coil spring.

FIG. 11 is a top view of an ordinary assembled system being applied to a spring motor.

FIG. 12 is a correspondence view of a feedback torque curve of an ordinary system that corresponds to the requirements for the curtain-folding process in a curtain set.

FIG. 13 is another preferred embodiment showing a torque curve implemented by the ordinary system.

FIG. 14 is a top view of a manufacturing machine according to the present invention.

FIG. 15 is a schematic view showing that the manufacturing machine is fed to a reed strip, according to the present invention.

FIG. 16 is a three-dimensional schematic view showing that the manufacturing machine is fed to the reed strip, according to the present invention.

FIG. 17 is a schematic view showing that the reed strip is formed into a coil, according to the present invention.

FIG. 18 is a schematic view showing the change in a center position of the coil, according to the present invention.

FIG. 19 is a top view showing that a front side of the machine is provided with a guiding device, according to the present invention.

FIG. 20 is a top view showing that the coil is poked reversely by the guiding device, according to the present invention.

FIG. 21 is a three-dimensional schematic view showing that a coiled section is cut by a shearing device, according to the present invention.

FIG. 22 is a three-dimensional schematic view showing a displacement action of a joggling wheel, according to the present invention.

FIG. 23 is a top view showing the displacement action of the joggling wheel, according to the present invention.

FIG. 24 is another top view showing the displacement action of the joggling wheel, according to the present invention.

FIG. 25 is a flow diagram of a manufacturing method of the present invention.

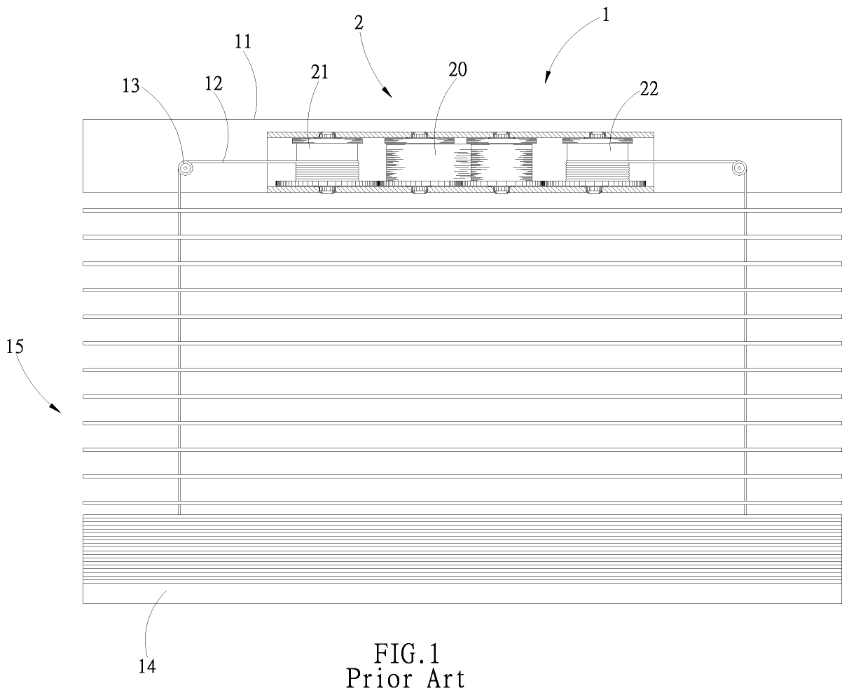

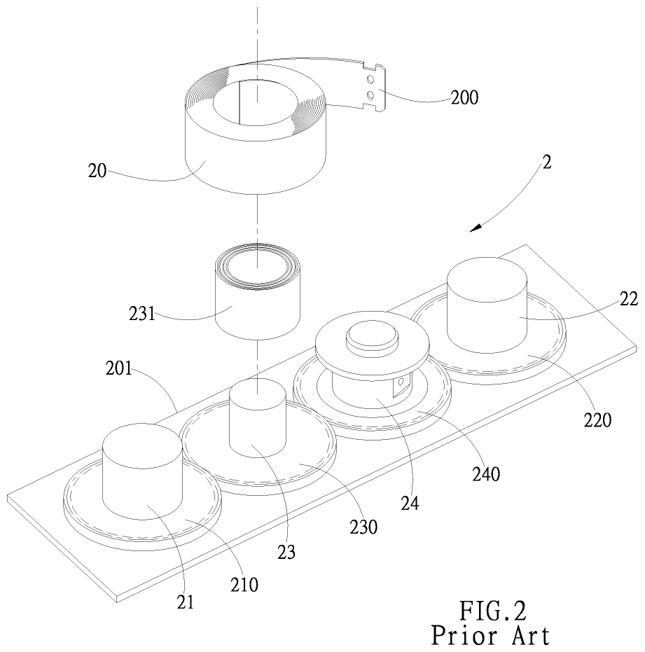

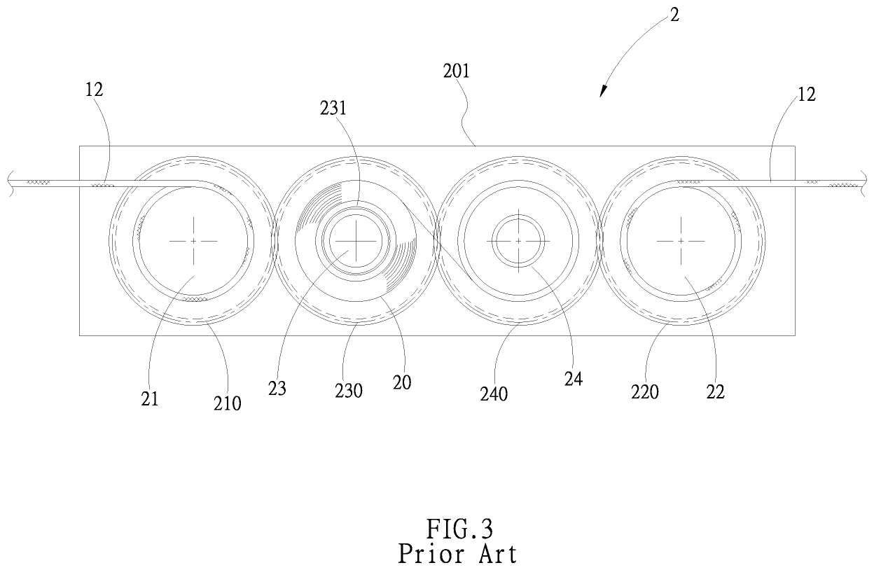

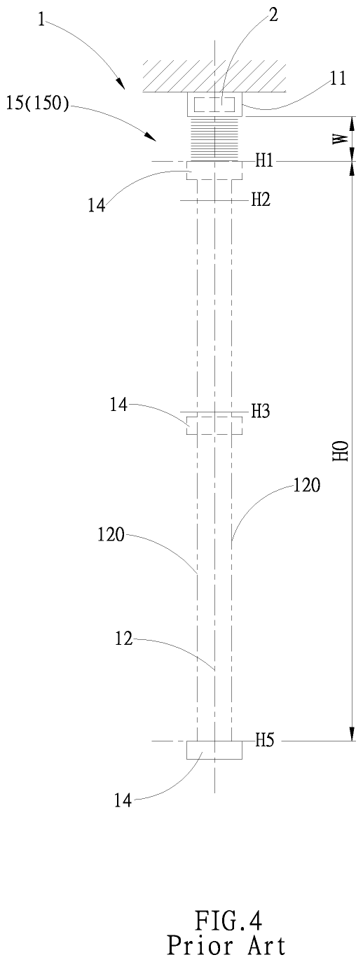

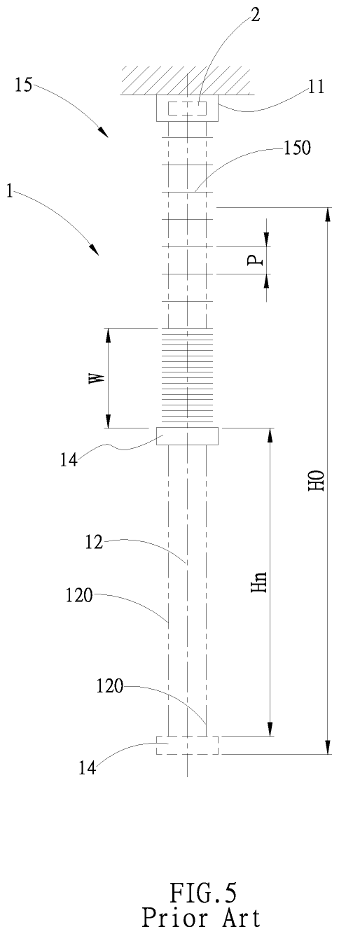

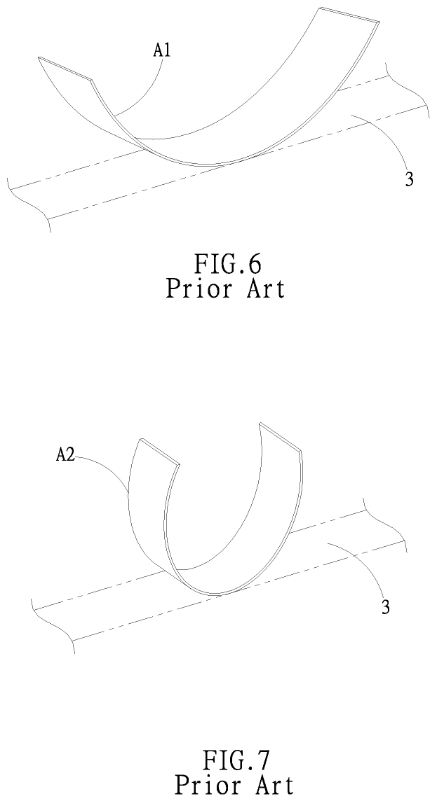

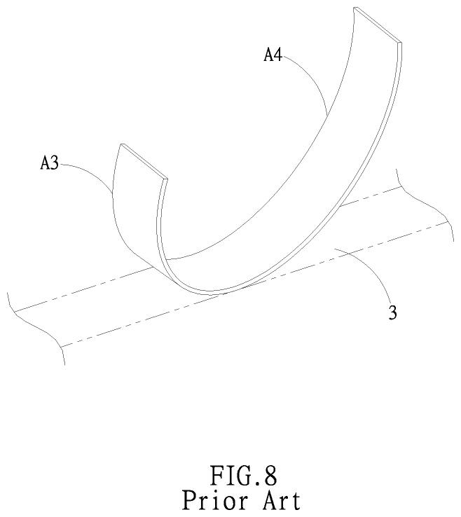

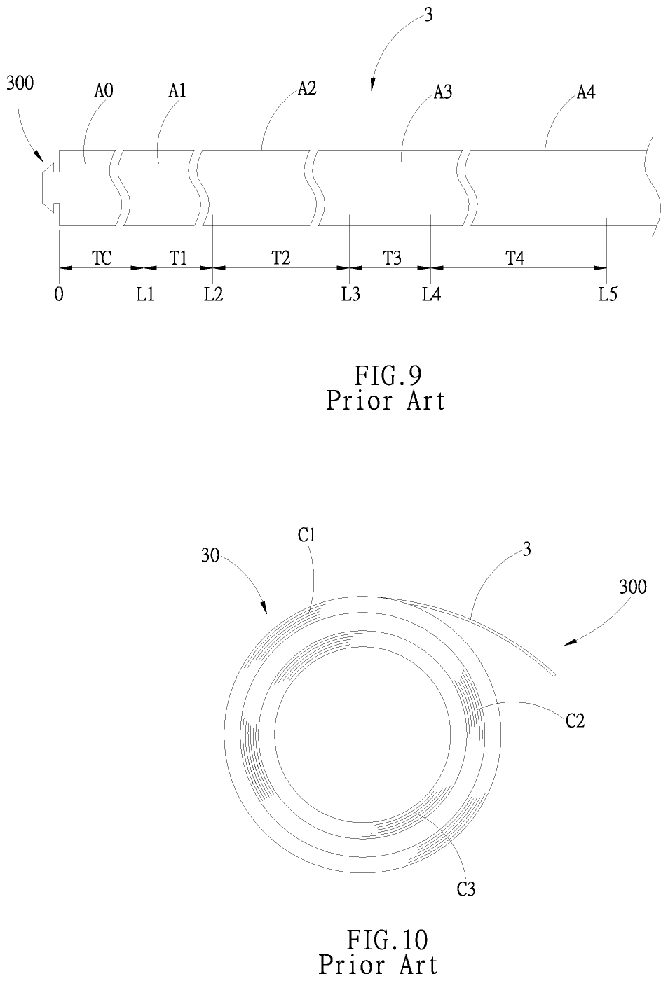

### DETAILED DESCRIPTION OF THE PREFERRED EMBODIMENTS

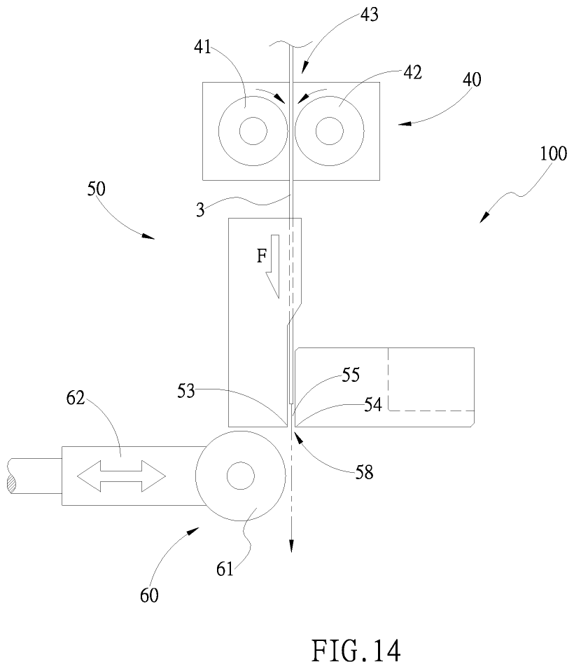

To achieve the aforesaid manufacturing method of the unequal-torque coil spring, the present invention employs a manufacturing machine 100 (as shown in FIG. 14), which comprises a delivery mechanism 40. The delivery mechanism 40 includes an entrainment wheel 41 and a rival wheel 42 which confronts the entrainment wheel 41 coaxially and parallel. A pushing route 43 is formed between two opposite surfaces of the two wheels to entrain a reed strip 3, forming a pushing force to feed the reed strip 3 toward a pillow module 50. The pillow module 50 is provided with a clipping gap 55 which is overlapped correspondingly on a movement route of the reed strip 3. An outer end of the pillow module 50 is formed with a discharging orifice 58 which is extended from the clipping gap 55, and two corner ends on a long side of the discharging orifice 58 are provided with a cutting angle 53 and a tip 54, respectively. An outer part of the discharging orifice 58 is provided with a bending device 60, and the bending device 60 is provided with a pushing arm 62 to push a joggling wheel 61. An axis of the joggling wheel 61 is parallel to the long side of the discharging orifice 58. By the displacement of the pushing arm 62, the oblique distance from the wheel surface of jogging wheel 61 to the tip 54 can be changed, or the distance between the vertical tangent of the jogging wheel 61 and the vertical center line of the discharging orifice 58 can be adjusted leftward or rightward. The collaboration between the aforesaid delivery mechanism 40 and the pillow module 50 provides the feed-in operation and curling operation in the manufacturing method of the present invention.

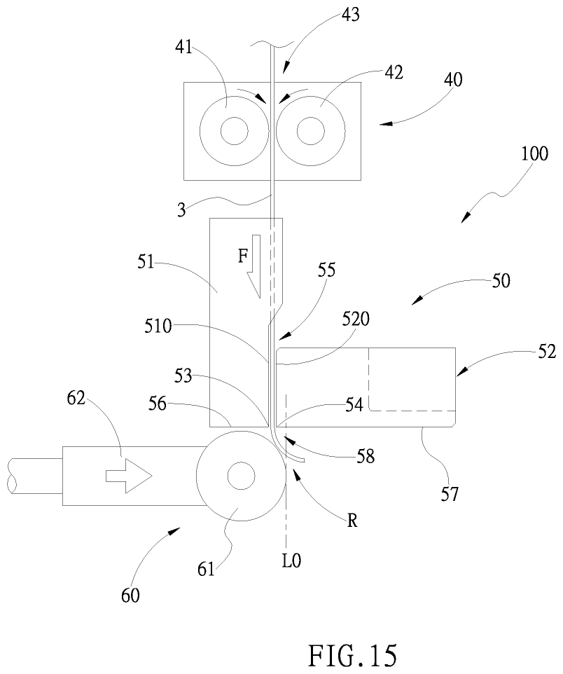

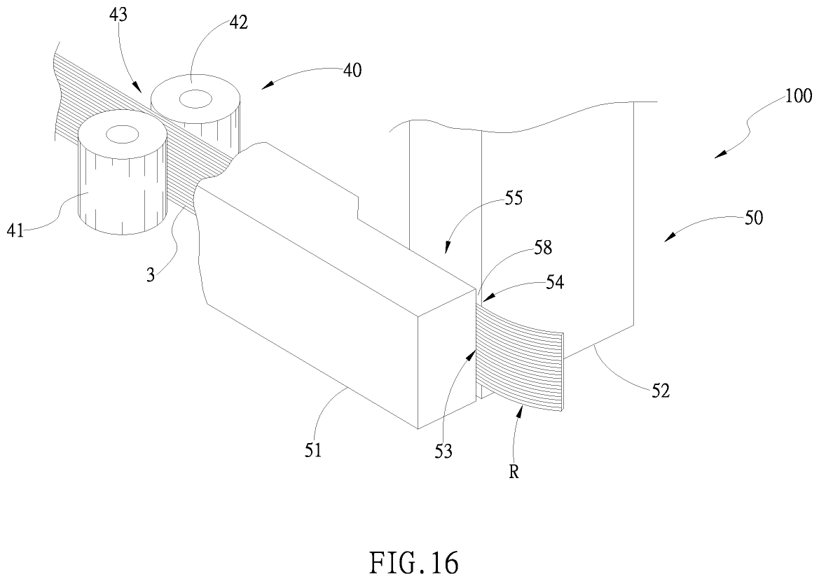

Please refer to FIGS. 15 to 20 for the curling operation of the aforesaid unequal-torque coil spring according to the present invention. First of all, as shown in FIG. 15 and FIG. 16, the delivery mechanism 40 provided by the manufacturing machine 100 utilizes its pushing route 43 to entrain a surface of the reed strip 3 to feed it toward the pillow module 50.

The pillow module 50 is provided with a side pressing block 51. The side pressing block 51 is provided with a sliding surface 510 and a pillow 52 opposite to the direction of delivery of the reed strip 3. A side of the pillow 52 opposite to the sliding surface 510 is provided with a confronting surface 520, and the clipping gap 55 is formed between the sliding surface 510 and the confronting surface 520. The outer end of the clipping gap 55 is the discharging orifice 58, and two side corners of the discharging orifice 58 are provided with the cutting angle 53 and the tip 54, respectively. The relative distance between the cutting angle 53 and the tip 54 is defined by the distance that extends from the inner part of the clipping gap 55 to the outer part of the clipping gap 55, and is also the width of the discharging orifice 58. The entrance of the clipping gap 55 is aligned to the pushing route 43 of the delivery mechanism 40, and the shape of the clipping gap 55 can be vertical or oblique, so that the discharging orifice 58 can be extended obliquely toward the pillow 52 (not shown in the drawings). Therefore, after exiting from the clipping gap 55, the reed strip 3 can be discharged obliquely at an angle less than 90° with respect to the sliding surface 57 of the pillow 52, allowing the joggling wheel 61 to joggle the reed strip 3 more easily.

When the reed strip 3, which is sent from the delivery mechanism 40, is discharged from the discharging orifice 58, the pushing arm 62 of the bending device 60 will act onto the joggling wheel 61 to displace toward the tip 54. In principle, the vertical tangent of the jogging wheel 61 should be beyond the discharging orifice 58 rightward, or the wheel surface of the jogging wheel 61 should be beyond the width of the clipping gap 55, so that the wheel surface and the tip 54 can result in continuous compression to the discharged reed strip 3. Additionally, the direction of displacement of the jogging wheel 61 should be parallel to the cutting plane 56 in principle, and the wheel surface can touch or close to the cutting plane 56 to displace. The primary posture is that the wheel surface of the jogging wheel 61 opposite to the tip 54 is able to bend the passing reed strip 3, deforming the surface thereof into a curled section R. Furthermore, by adjusting the displacement of the jogging wheel 61, the curvature of the curled section R can be changed.

In the aforesaid process, entrainment force will be formed on the pushing route 43 between the entrainment wheel 41 and the rival wheel 42 of the delivery mechanism 40, pushing the reed strip 3 to move toward the pillow module 50 and resulting in compressible compression force F to feed the reed strip 3 out of the discharging orifice 58. In addition, the width of the clipping gap 55 fits the tolerance in thickness of the reed strip 3, so that the reed strip 3 can pass through and slide in the clipping gap 55. On the other hand, when the reed strip 3 slides through the clipping gap 55, the counteraction force that is formed when the strip is joggled by the jogging wheel 61 is absorbed by the sliding surface 510 of the side pressing block 51.

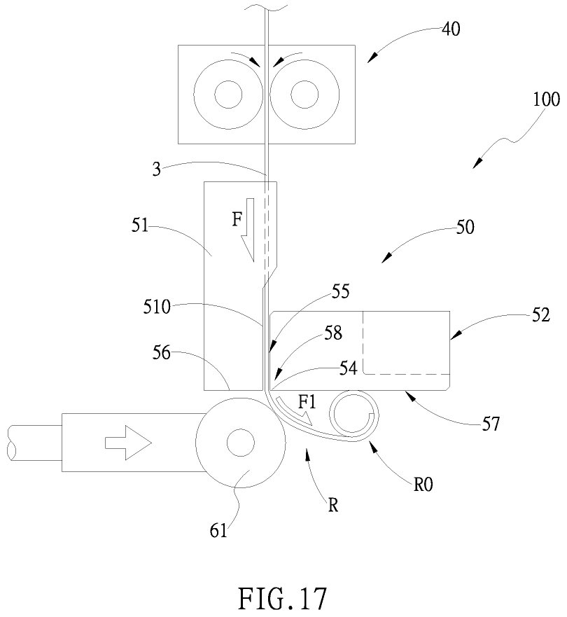

Referring to FIG. 17 again, when the manufacturing machine 100 utilizes the provided pillow module 50 to receive the reed strip 3 that is pushed from the delivery mechanism 40 to enter the clipping gap 55, the reed strip 3 will be fed out of the discharging orifice 58 via the clipping gap 55. In the process, the reed strip 3 is subjected to side compression from the joggling wheel 61 to the tip 54, forming into the curled section R after being fed out. As the reed strip 3 is fed out continuously, due to the time accumulation, the curled section R will be coiled by itself into a loop. The subsequent reed strip 3 will form the first pushing force F1 by the elasticity and tension of the strip itself. The first pushing force F1 will develop into a coil R0, and the apex of the coil R0 will be abutted on the sliding surface 57 tangentially. In addition, as the length of the curled section R that is pushed out of the discharging orifice 58 is unable to meet the perimeter of the coil R0 yet, the curled section R is in a shape of an arc.

The jogging wheel 61 acts onto the tip 54, shearing the discharging end of the reed strip 3 to form the curled section R. The action force acts onto the wheel surface of the jogging wheel 61, opposite to the tangent of the tip 54, with an oblique angle with respect to the tip 54. A front section of the reed strip 3 is disposed on a left side inside the clipping gap 55, abutting at the sliding surface 57 to absorb the counteraction force. Therefore, the strip tissue of the reed strip 3 that passes through the discharging orifice 58 will be bent to form the curled section R; whereas, the accomplished coil R0 will slide on the sliding surface 57 of the pillow 52, resulting in an accumulated coil layer by curling itself.

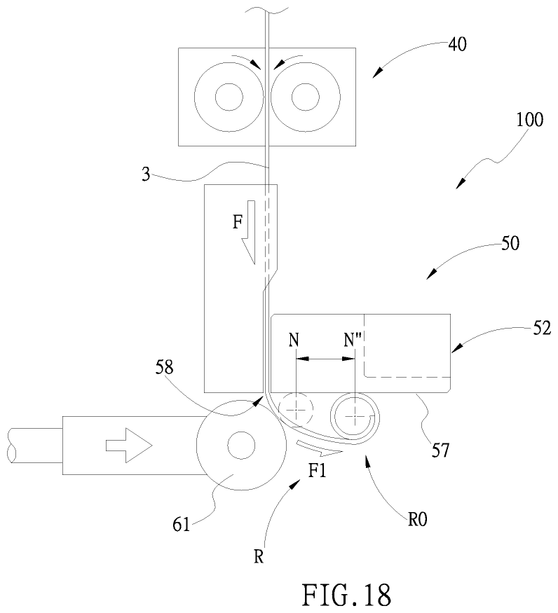

Referring to FIG. 18 again, the reed strip 3 is pushed toward the pillow module 50 by the delivery mechanism 40, and the pushing forms the compressible compression force F, so that the reed strip 3 can be bent by the jogging wheel 61 from the exit of the discharging orifice 58. For the first formed coil R0, its center location N is close to the discharging orifice 58 as its diameter of coil is smaller. After that, as the layer will increase the diameter, along with the subjection to the first pushing force F1 and the elasticity and tension of the curled section R, the coil R0 will be pushed toward the sliding surface 57, tuning into a second center location N′. Without the interference of external force, the coil R0 will be curled by itself to accumulate into the coil R0 in multiple layers as time goes by. The coil R0 can be cut after accomplishing the curling.

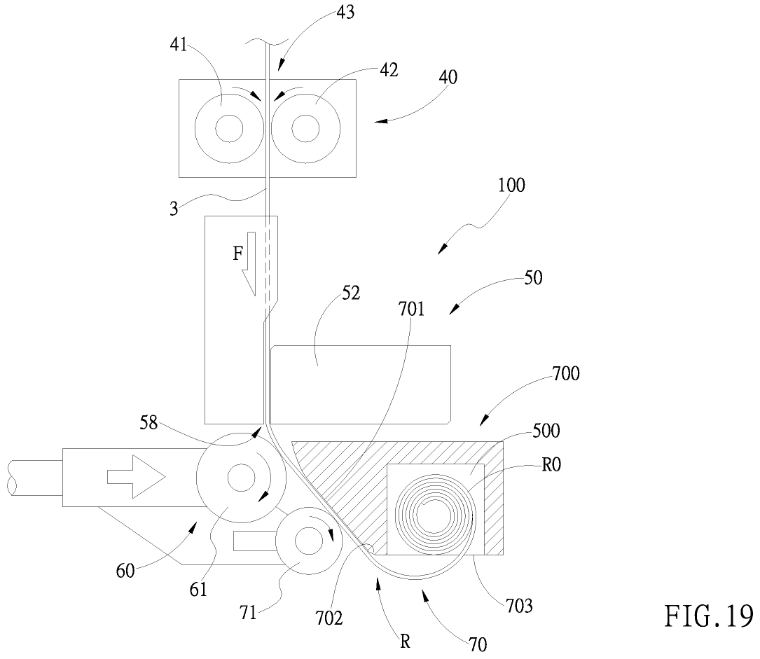

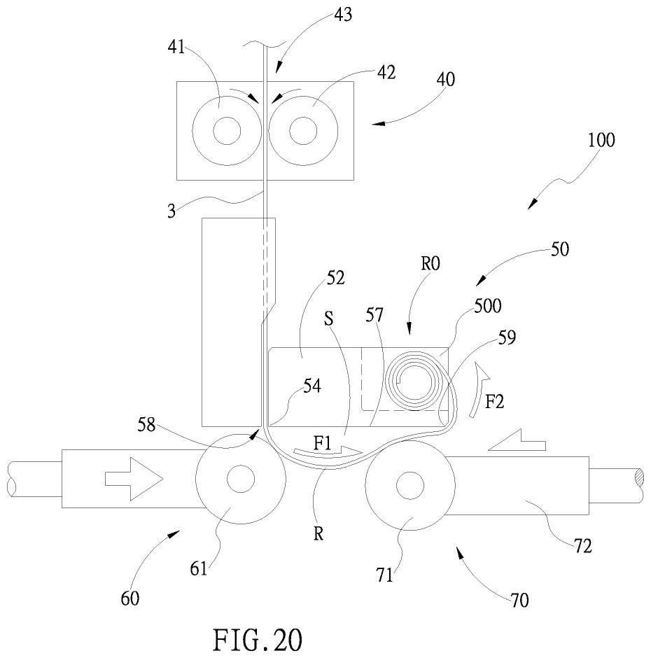

Regarding the collecting process for making the coil R0, a guiding and collecting operation can be executed by the backend structures. As shown in FIG. 19 and FIG. 20, there is a chamber 500 for accommodating the bent reed strip 3 to be collected, so that the upper and lower end surfaces of the coil can be even.

First of all, referring to FIG. 19, a guiding device 70 is provided with a guiding wheel 71 which is parallel to the axis of the joggling wheel 61 and acts synchronously with the jogging wheel 61, as well as a connector 700 which is provided with a guiding slope 701 having an entrance that faces the discharging orifice 58. The surface of the guiding slope 701 is parallel to the wheel surface of the jogging wheel 61 or the guiding wheel 71, a clamping gap can be adjusted between the guiding wheel 71 and the guiding slope 701, and an outer end of the guiding slope 701 is connected with an edge 702. The edge 702 is connected to the chamber 500 which is disposed in the connector 700, and the connector 700 includes an opening 703. The connector 700 is connected with the pillow module 50, or can displace relative to the pillow 52. By using the aforesaid structures, an ordering and collecting process can be implemented onto the coil R0 via guidance. The reed strip 3 is fed by the delivering mechanism 40, and is operated by the pillow module 50 and the bending device 60. After that, the reed strip 3 exists from the discharging orifice 58. The curled section R at the exit is driven by the guiding slope 701 of the guiding device 70 to pass through the guiding wheel 71. After being driven or rolled by the guiding wheel 71, the curled section R passes around the edge 702 according to the bending stress thereof and enters the chamber 500. The curled section R is defined by the inner surface of the chamber 500, so that the upper and lower axial end surfaces of the coil R0 can be evenly collected. Finally, the single body of coil R0 is cut, and the accomplished single body will drop out of the opening 703.

Referring to FIG. 20 again, in the collecting process for making the coil R0, the machine can be more simplified if the chamber 500 is disposed on a back side of the pillow 52.

The guiding device 70 is provided with the guiding wheel 71 that displaces by a pushing arm 72 to access in an outer space of the sliding surface 57. On the other hand, the wheel surface of the guiding wheel 71 can be abutted at the sliding surface 57, resulting in clamping force between the wheel surface and the sliding surface 57 to access in whole relative to the discharging orifice 58. The axis of the guiding wheel 71 is parallel to the jogging wheel 61, and after the curled section R enters the clamping gap, the wheel surface will shear on the outer surface of the curled section R. By the elasticity and tension of the strip of the curled section R, the outer surface of the initially accomplished curled section R will be compressed or rolled by the wheel surface of the guiding wheel 71, sliding over the sliding surface 57 and feeding toward a rear poking angle 59. Finally, the curled section R will slide over the rear poking angle 59, forming second pushing force F2 to push the coil R0 to the other side of the pillow 52 (such as the rear side), followed by entering the chamber 500. Therefore, the guiding and collecting operation is accomplished. As shown in the drawing, the coil R0 can be poked backward via the rear poking angle 59, and the coil R0 will be curled autonomously into a layer by the elastic coiling force thereof. After the cutting operation, the single body of coil R0 will drop out of the chamber 500, resulting in a required unequal-torque coil spring 30 as shown in FIG. 10.

The reed strip 3 at the exit of the discharging orifice 58 will be pressed continuously by the bending device 60. Similarly, the first pushing force F1 formed by the mechanical tension of the curled section R itself will push the initially accomplished curled section R toward the rear poking angle 59. During the process, the pressing and guiding force from the guiding device 70 is utilized to drive the curled section R toward the rear poking angle 59, so that the coil R0 can be accommodated in the chamber 500 behind the rear poking angle 59. In the aforesaid pressing and guiding process executed by the guiding wheel 71 to the outer curve of the passing curled section R, due to the pressing force, part of the tissue structures that are altered by the bending of the body of reed strip 3 that was previously joggled by the joggling wheel 61 can be relocated reversely, so that a disengaging gap can be formed in the tissues.

The curled section R is driven by the guiding wheel 71. Except for the pressing point, between the exit of the discharging orifice 58 and the guiding wheel 71, due to the deformation tension of the curled section R itself, the strip body will be bulged out of the sliding surface 57, forming a feed-in operation space S.

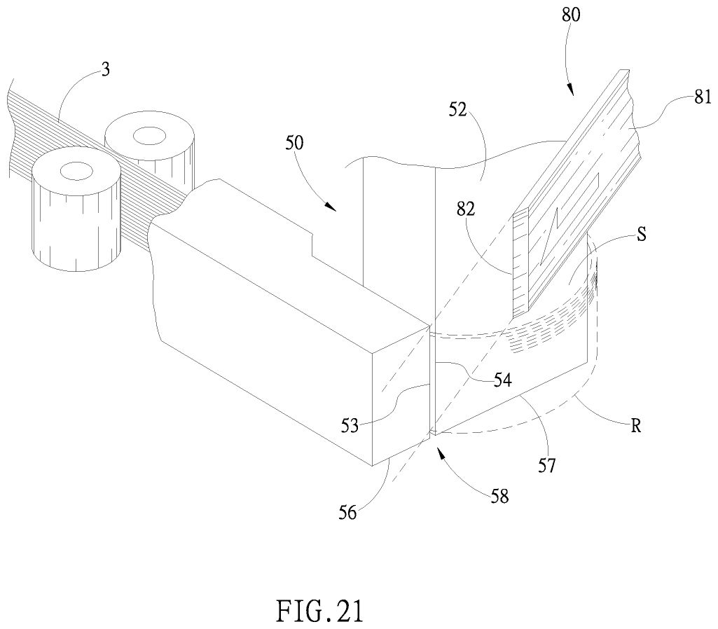

Referring to FIG. 21 again, the feed-in operation space S provides a cutting device 80 with an inner cutting space. The cutting device 80 is provided with a cutting tool 81, and a cutting lip 82 can move inside the feed-in operation space S, acting on the inner side of the curled section R and performing the cutting operation in association with the cutting angle 53 of the discharging orifice 58. After the cutting lip 82 of the cutting tool 81 feeds in and slides over the discharging orifice 58, the cutting lip 82 will slide on a cutting plane 56 which is even with the front face of the cutting angle 53. In addition, the body of cutting tool 81 can slide on the front face of the pillow 52, and the sliding surface 57 of the pillow 52 can also act as a sliding plane for the cutting tool 81.

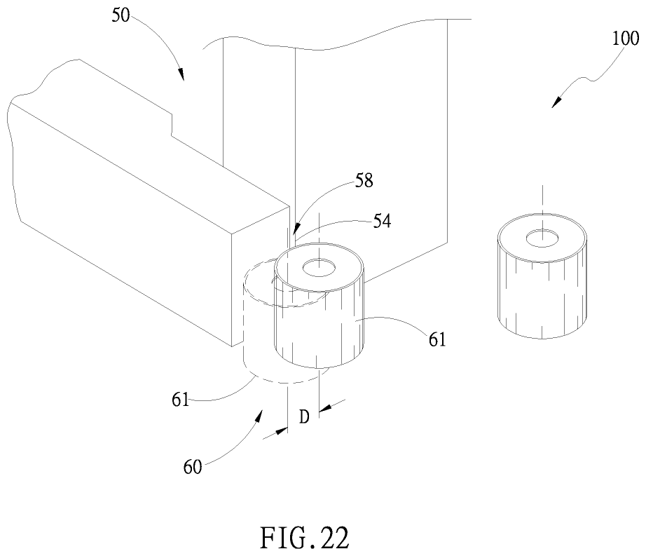

In terms of the elastic change to the inner and outer layers of the unequal-torque coil spring, the present method is able to accomplish this via a warping operation. In the aforesaid curling operation, the curvatures in the front and rear sections of the reed strip 3 can be tuned using the adjustment of the curling process, as shown in FIGS. 22 to 24.

First of all, as shown in FIG. 22, the outer periphery of the discharging orifice 58 of the pillow module 50 is provided with a joggling wheel 61 which moves relative to the discharging orifice 58. The joggling wheel 61 can be adjusted rightward and leftward and by using the displacement of an adjustment stroke D, the tangent on the wheel surface relative to the tip 54 can change in oblique distance relative to the tip 54.

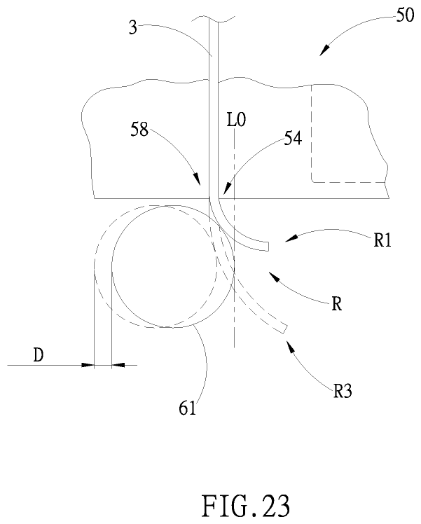

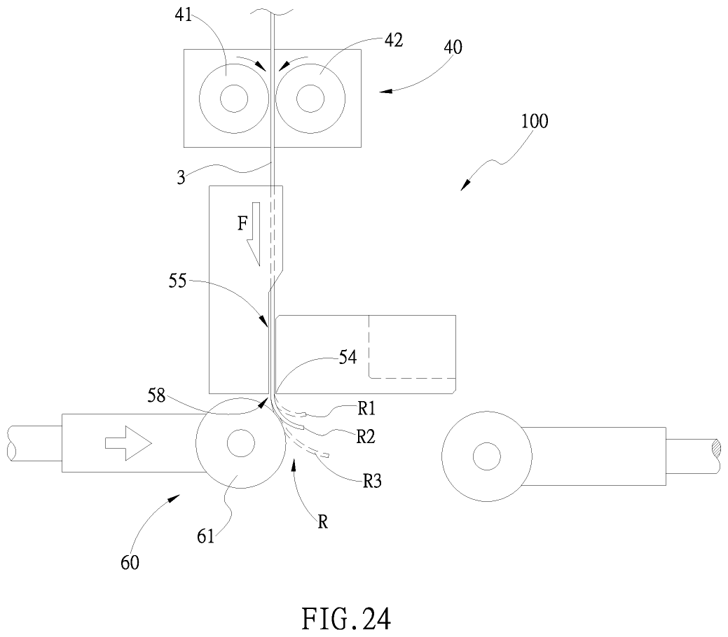

Referring to FIG. 23 and FIG. 24, when the wheel surface of the jogging wheel 61 changes in the oblique distance relative to the tip 54, for example, when a vertical tangent L0 on the wheel surface moves rightward beyond the width of the discharging orifice 58 via tuning the adjustment stroke D, the reed strip 3 can be made to displace obliquely at the exit of the discharging orifice 58, and the reed strip 3 can be bent and sheared. By the adjustment stroke D, the jogging wheel 61 can be tuned rightward to bend the reed strip 3 into a large curvature, forming the curled section R into a large-curvature curled section R1. On the other hand, when the jogging wheel 61 is pushed leftward, the curled section R will be formed into a small-curvature curled section R3. By the tuning of the adjustment stroke D, the jogging wheel 61 can bend the reed strips 3 into the curled sections R in various curvatures, and different curvatures will result in different elastic energy.

Referring to FIG. 24 again, the reed strip 3 is fed toward the clipping gap 55 by the delivery mechanism 40 and is discharged from the discharging orifice 58. The discharging orifice 58 is outward provided with a bending device 60 which can adjust the displacement. The vertical tangent of the bending device 60 is opposite to the discharging orifice 58, or can be adjusted relative to the oblique distance to the tip 54. If the vertical tangent moves rightward beyond the tip 54, the curled section R will be formed into a large-curvature curled section R1, a middle-curvature curled section R2 and a small-curvature curled section R3, orderly. With the similar adjustment, the curvature of the reed strip 3 after exiting from the discharging orifice 58 can be changed.

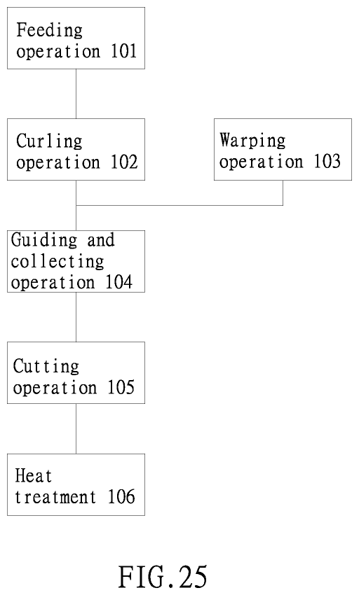

In the aforesaid fabrication process provided by the manufacturing machine 100, the processing method is shown in FIG. 25. First of all, a feeding operation 101 and a curling operation 102 as shown in FIGS. 15 to 20 are executed. During the curling operation 102, a warping operation 103 as shown in FIGS. 22 to 24 is introduced. Next, a guiding and collecting operation 104 as shown in FIG. 19 and FIG. 20 proceeds. After that, a cutting operation 105 as shown in FIG. 21 is carried out. The product after cutting undergoes a heat treatment 106 to adjust the electronic structures inside the metal tissues.

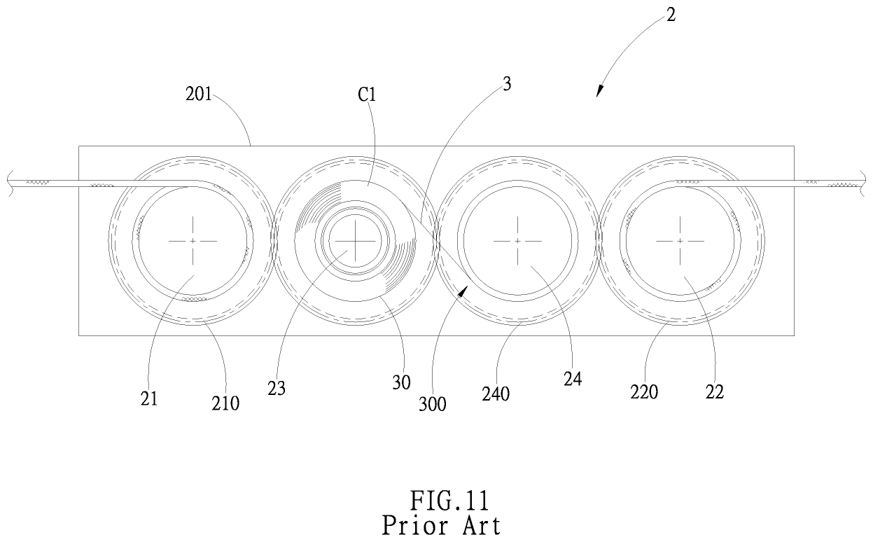

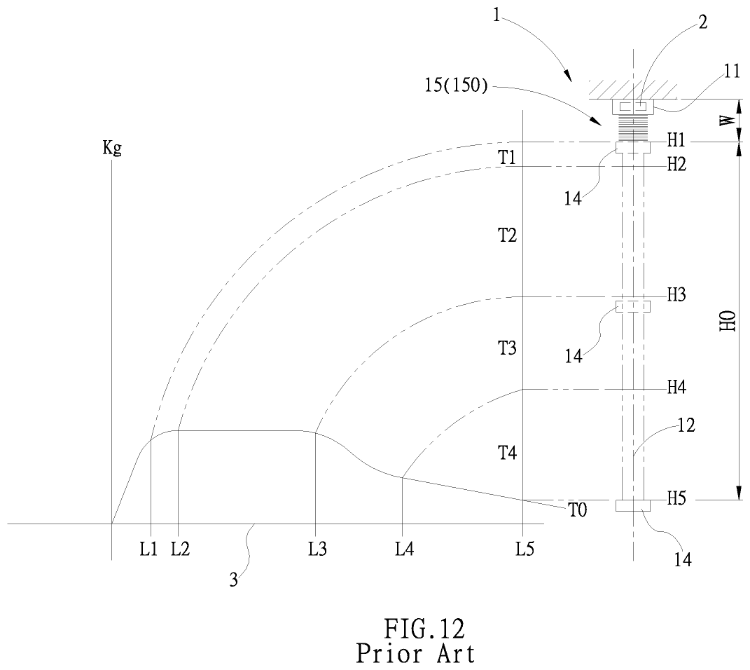

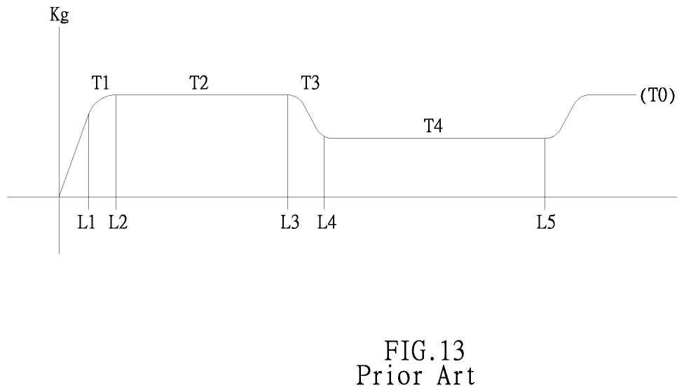

In the fabrication process, if the curvature of the inner layer of the unequal-torque coil spring is first made to be larger than that of the outer layer, then the reacted elastic energy will be larger. After accomplishing this fabrication process, the inner layer and the outer layer can be interchanged by a reversing method, so that the inner layer of the unequal-torque coil spring, with larger elastic energy, can be reversely wrapped on the outer layer, enabling the large-curvature part to be wrapped on the outer layer instead. The result of reversing the inner layer with the outer layer can provide energy distribution under a static condition while the manufacturing machine is online, as shown in FIG. 11; this can be used in a condition requiring larger elastic energy. Therefore, when making the coil spring, the coil in a large curvature can be curled first by this reversion of the inner layer with the outer layer.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A manufacturing method of an unequal-torque coil spring for a curtain spring motor, providing feedback torque from the unequal-torque coil spring in response to requirements for different forces in different stages of a curtain-folding working process to result in different corresponding torque for stabilizing the speed of folding back the curtain and fixing a lower beam of the curtain at any heights as the curtain is lowered, comprising steps of:
a) a feed-in operation, which is executed by a delivery mechanism, producing a forward pushing force to a reed strip along a pushing route provided;
b) a curling operation, which is executed by a pillow module to support the movement of the reed strip, feeding out the reed strip continuously from a provided discharging orifice, with the reed strip being abutted at a tip opposite to the discharging orifice and disposed on a wheel surface of a joggling wheel provided by a bending device and axially parallel to a long side of the discharging orifice, and the reed strip being sheared continuously to warp into a curled section which is accumulated to a coil progressively;
c) a warping operation, in which an axial distance between the wheel surface of the joggling wheel and the tip is changed to alter the curvatures at a front and rear section of the compressed and warped reed strip, in the curling operation;
d) a cutting operation, in which a cutting tool provided by a cutting device is utilized to cut the accomplished coil at the discharging orifice; and
e) a heat treatment, which sets and intensifies the metallic tissues of the cut coil.

2. The manufacturing method of an unequal-torque coil spring for a curtain spring motor, according to claim 1, wherein the warping operation utilizes a pushing arm to drive an axis of the joggling wheel to displace.

3. The manufacturing method of an unequal-torque coil spring for a curtain spring motor, according to claim 1, wherein during the curling operation, a guiding device is utilized to poke the curled section to the other side of a pillow, forming the feed-in operation space between an inner side of the curled section and a sliding surface of the pillow.

4. The manufacturing method of an unequal-torque coil spring for a curtain spring motor, according to claim 1, wherein the changing in the curvature in the warping operation is configured into a distribution in a large and small arc progressively, allowing various elastic energy to be formed in an inner and outer layer of the accomplished coil.

5. A manufacturing machine of an unequal-torque coil spring for a curtain spring motor, providing feedback torque from the unequal-torque coil spring in response to requirements for different forces in different stages of a curtain-folding working process to result in different corresponding torque for stabilizing the speed of folding back the curtain and fixing a lower beam of the curtain at any heights as the curtain is lowered, comprising:
a delivery mechanism which is provided with a pushing route to feed a reed strip;
a pillow module which is provided with a space corresponding to a clipping gap of the pushing route, with an outer end of the clipping gap being a discharging orifice, a corner end on a long side of the discharging orifice being a cutting corner, and the other end being a tip;
a bending device which is provided with a joggling wheel having the axis parallel to the long side of the discharging orifice, with a distance between a tangent on the wheel surface of the jogging wheel and the tip being adjusted by a pushing arm; and
a cutting device which is provided with a cutting tool to perform a cutting operation in accordance with a cutting angle.

6. The manufacturing machine of an unequal-torque coil spring for a curtain spring motor, according to claim 5, wherein the pillow module is provided with a side pressing block having a sliding surface to confront a pillow, with the pillow being provided with a confronting surface opposite to the sliding surface, and a clipping gap being formed between the sliding surface and the confronting surface to feed out the reed strip.

7. The manufacturing machine of an unequal-torque coil spring for a curtain spring motor, according to claim 6, wherein the pillow is provided with a rear poking angle on the other side opposite to the tip, and a movable guiding device is disposed at the outer periphery of the rear poking angle to face the sliding surface of the pillow and is provided with a pushing arm to drive a guiding wheel, with the driving wheel being opposite to the surface of pillow and an axis of the driving wheel being parallel to the joggling wheel.

8. The manufacturing machine of an unequal-torque coil spring for a curtain spring motor, according to claim 5, wherein the guiding device is provided with a connector on a front surface of the side pressing block, the connector is provided with a guiding slope having an entrance facing the discharging orifice, the guiding slope is engaged with a chamber via an edge, and a guiding wheel is axially parallel to the joggling wheel and is disposed outside the joggling wheel, acting synchronously with the joggling wheel.

9. The manufacturing machine of an unequal-torque coil spring for a curtain spring motor, according to claim 5, wherein the front surface of the side pressing block is aligned with the cutting angle, and the side pressing block is provided with a cutting plane on which the cutting tool slides.

10. The manufacturing machine of an unequal-torque coil spring for a curtain spring motor, according to claim 5, wherein the front surface of the pillow is aligned with the tip, and the pillow is provided with a sliding surface on which the cutting tool slides.

11. The manufacturing machine of an unequal-torque coil spring for a curtain spring motor, according to claim 5, wherein the delivery mechanism is provided with an entrainment wheel to confront a rival wheel, and a pushing route is formed between the entrainment wheel and the rival wheel to carry the board of reed strip.

12. The manufacturing machine of an unequal-torque coil spring for a curtain spring motor, according to claim 5, wherein a tangent on the wheel surface of the joggling wheel is oblique opposite to the tip, and the tangent on the right side of wheel surface passes rightward beyond the discharging orifice.
